(19) United States
(12) Patent Application Publication
(10) Pub. No.: US 2002/0142248 A1
(43) Pub. Date: Oct. 3, 2002

(54) Secure, optically-readable data medium

(76) Inventors: Jean-Claude Dubois, Magny-Les-Hameaux (FR); Maurice Milgram, Paris (FR)

Correspondence Address: MARSHALL, GERSTEIN & BORUN, 6300 SEARS TOWER, 233 SOUTH WACKER, CHICAGO, IL, 60606-6357, US

(21) Appl. No.: 09/945,559

(22) Filed: Aug. 30, 2001

(30) Foreign Application Priority Data
Sep. 4, 2000 (FR) FR 00 11230
May 4, 2001 (FR) FR 01 06004

(51) Int. Cl. G11B 7/24; G11B 7/00

(52) U.S. Cl. 430/270.15; 369/53.22; 369/108; 430/945

(57) ABSTRACT

A secure, optically readable data medium comprises a data-carrying zone readable by a read light beam, and at least a portion that is photosensitive, being provided with a photosensitive material and exposed to the read light beam. The photosensitive material contains an active compound taken from the family of diarylethenes.

### FIELD OF THE INVENTION

The present invention relates to secure, optically-readable data media.

More particularly, the invention provides a secure, optically readable data medium comprising a data-carrying zone that is readable by a read light beam, and at least a portion that is photosensitive, being provided with a photosensitive material and exposed to the read light beam, the photosensitive material presenting at least one optical property that can be modified by the read light beam.

### BACKGROUND OF THE INVENTION

Document EP-A-0 903 732 describes an example of such a data medium in which the photosensitive material is constituted in particular by lithium niobate. The data medium described in that document gives satisfaction, but lithium niobate suffers from the drawback of requiring a relatively large amount of light energy in order to change optical state. Given the relatively low power of commonly-used read light beams, it is therefore necessary to expose the photosensitive material for a relatively long period of time to the read light beam in order to cause the material to change optical state.

More generally, all photosensitive materials that have been used until now for the purpose of making data media secure have suffered from that drawback, and in some cases that has even made it necessary to use a laser beam that is different from the read beam in order to change the state of the photosensitive material. There therefore exists a need for a photosensitive material presenting change-of-state energy that is small enough to ensure that changing state does not lead to the process of reading the data medium being slowed down excessively.

### OBJECTS AND SUMMARY OF THE INVENTION

A particular object of the present invention is to satisfy this need.

To this end, the invention provides a data medium of the kind in question which is characterized in that the photosensitive material contains an active compound taken from the diarylethene family.

Changing the optical state of this particular photosensitive material requires light energy that is small enough, given the powers of commonly-used read light beams, to ensure that the change in optical state occurs in an extremely brief exposure time.

Furthermore, this photosensitive material also presents the advantage of being sensitive to the wavelengths commonly used in light beams for reading data media.

In preferred embodiments of the invention, use may optionally also be made of one or more of the following dispositions:

the compound from the family of diarylethenes is a substituted or non-substituted compound having the following general formula:

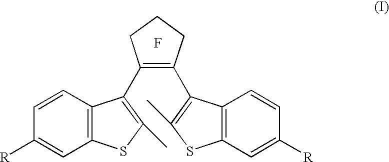

in which R represents a substituted or non-substituted styryl radical;

the compound from the family of diarylethenes is a substituted or non-substituted compound having the following general formula:

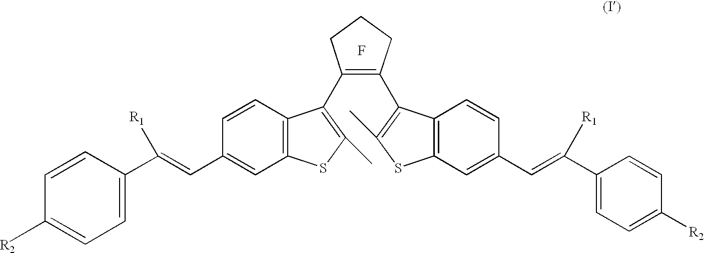

in which:

R₁ and R₂ are each selected independently of each other from: a hydrogen atom; a C1 to C6 alkyl group; and a C1 to C6 alcoxy group;

R₁ represents a hydrogen atom and R₂ represents —O—CH₃;

R₁ represents CH₃ and R₂ represents a hydrogen atom;

the compound from the family of diarylethenes is a substituted or non-substituted compound having the following general formula:

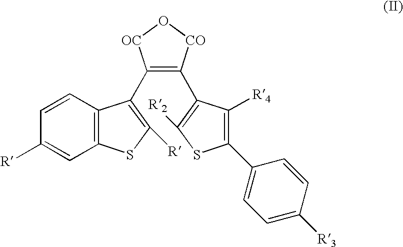

in which each of R′, R′₁, R′₂, R′₃, and R′₄ is selected independently of one another from: a hydrogen atom; an alkyl group; and an alcoxy group;

R′represent a hydrogen atom, R′₁ represents —O—CH₃, R′₂ and R′₄ represents CH₃, and R′₃ represents —O—CH₃;

the data medium is an optical disk;

the data medium is selected from compact disk read only memories (CD-ROMs) and digital video disks (DVDs);

the data medium has a data zone which includes at least part of said photosensitive portion;

the data medium comprises a transparent matrix having a data-carrying face on which said photosensitive material is deposited in the form of a fine layer, the layer of photosensitive material and the data-carrying face of the matrix being covered in a reflecting layer of metallization;

the photosensitive material is in the form of a layer of thickness lying in the range 0.2 microns (μm) to 10 μm, which thickness can be as great as 60 μm;

the photosensitive material also comprises a solid transparent polymer having the active compound of said photosensitive material mixed therein;

the active compound is at a concentration of 10% to 30% by weight relative to the transparent polymer;

the photosensitive material is blue in color and is adapted to fade on receiving sufficient light energy in a wavelength range that includes the wavelength value 635 nanometers (nm);

the photosensitive material is colorless and is adapted to become colored blue on receiving sufficient light energy in a wavelength range lying at least in part in the range 300 nm to 400 nm;

the photosensitive portion of the data medium is covered by a removable opaque mask;

the data medium constitutes a DVD comprising two substrates bonded together by means of an intermediate layer formed at least in part by said photosensitive material, said intermediate layer comprising at least the active compound of said photosensitive material together with a solid transparent polymer which adheres to both substrates of the DVD;

said transparent polymer is a photopolymer; and

said photopolymer is adapted to polymerize on

being irradiated with ultraviolet radiation.

Besides, another object of the invention is a process for checking that an optically readable data medium is an original, said optically readable data medium comprising a data carrying zone that is readable by a read light beam and at least a portion that is photosensitive, being provided with a photosensitive material and exposed to the read light beam, the photosensitive material presenting at least one optical property that can be modified by the read light beam, the photosensitive material containing an active compound taken from the diarylethenes family,

said process comprising at least a first step in which the data medium is read by said read light beam, and a second step in which one checks that said at least one optical property of the photosensitive material was modified during said first step.

### BRIEF DESCRIPTION OF THE DRAWINGS

Other characteristics and advantages of the invention will appear on reading the following description of two embodiments given as non-limiting examples and with reference to the accompanying drawing.

In the drawing:

FIG. 1 is a plan view of an optical disk constituting an embodiment of the invention;

FIG. 2 is a detail view in section of the optical disk of FIG. 1, when it comprises a CD-ROM; and

FIG. 3 is a detail view in section of the optical disk of FIG. 1, when it comprises a DVD.

### MORE DETAILED DESCRIPTION

In the various figures, the same references are used to designate elements that are identical or similar.

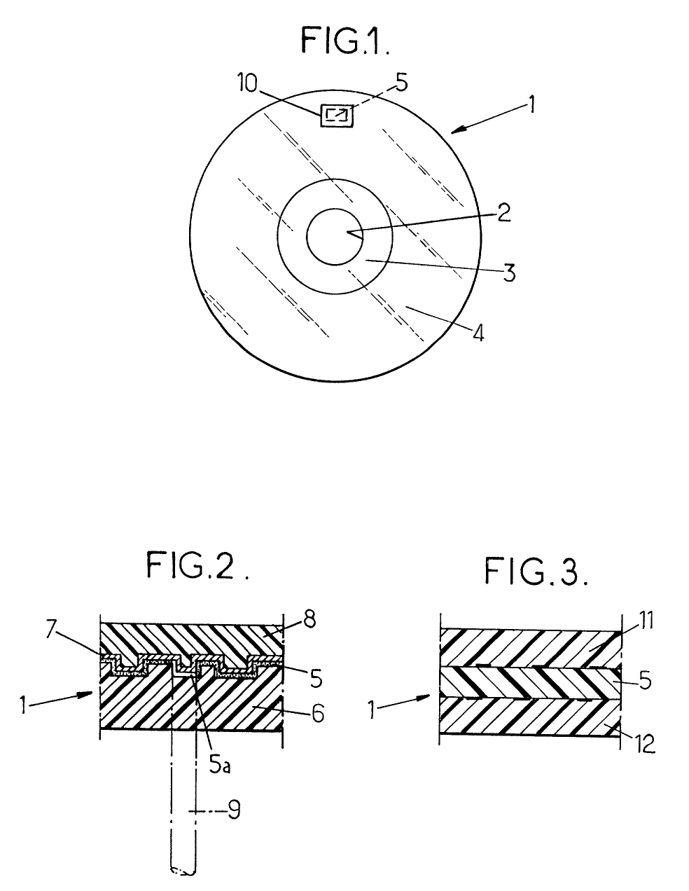

FIG. 1 shows an optical disk 1, in particular of the CD-ROM or DVD type, having a central hole or hub 2 surrounded by annular zone 3 that does not carry any data, itself surrounded by a data zone 4 which comprises helical read tracks for exposure to a read light beam, in particular a laser beam, when the optical disk is mounted in an appropriate reader.

The data zone 4 contains at least one photosensitive portion 5 which, where appropriate, can constitute the entire data zone 4 or the entire surface of the disk 1, or which could optionally occupy only the data-free zone 3, providing it is possible to expose the photosensitive portion 5 to the read light beam. Advantageously, this photosensitive portion 5 can be covered by an opaque peel-off label 10 or by some other opaque mask (in particular the packaging of the optical disk 1) prior to first use of the optical disk 1.

As shown in FIG. 2, which applies to the particular case of a CD-ROM, the photosensitive portion 5 can be in the form of a fine layer of photosensitive material, of thickness that can lie in the range 0.2 μm to 10 μm, and advantageously lies in the range 0.5 μm to 5 μm, for example being close to 4 μm. Nevertheless, this thickness could be greater and could be as much as 60 μm, for example.

This layer 5 can be placed in particular on the data-carrying surface of the transparent matrix 6 of the optical disk, which matrix is conventionally made of plastics material, e.g. out of polycarbonate. In addition, the photosensitive layer 5, like the remainder of the data-carrying surface of the matrix 6, can be covered in conventional manner by a fine layer of metallization 7 which makes it possible to read the disk 1 by reflecting a read laser beam 9 which passes through the transparent matrix 6, and the layer of metallization 7 is itself covered, on its face remote from the matrix 6, in a protective layer 8 of polycarbonate or of some other plastics material.

According to the invention, the photosensitive material used in the portion 5 of the optical disk comprises an active compound which is a photochromic compound constituted by a compound in the diarylethene family.

A first example of this compound is preferably 1,2-(2-methyl)-benzothiophene-3-yl perfluorocyclopentene (or substituted compounds thereof) having the following developed formula:

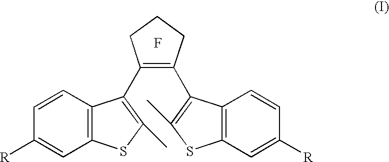

in which R represents a substituted or non-substituted styryl radical.

In a variant of this example, the compound is 1,2-(6-styryl-2-methyl)-benzothiophene-3-yl perfluorocyclopentene (or substituted compounds thereof) having the following developed formula:

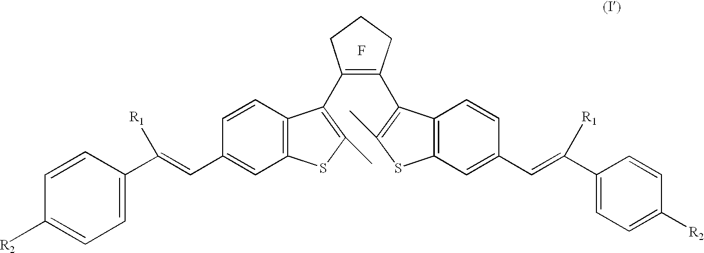

in which R₁ represents, e.g. a hydrogen atom, and R₂ represents, e.g. a methoxy group, such as —O—CH₃, in particular.

Alternatively, R₁ represents, e.g. an alkyl group such as CH₃ in particular, and R₂ represents, e.g. a hydrogen atom.

A second example of this compound is preferably 1,2-(benzothiophene-3-yl, 5-phenylthiophene-3-yl)maleic anhydride (or substituted compounds thereof), having the following developed formula:

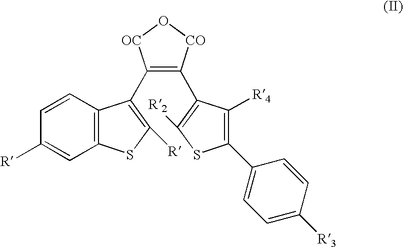

In a variant of this example, R′represents, e.g. a hydrogen atom, R′₁ represents, e.g. a methoxy group such as —O—CH₃ in particular, R′₂ represents, e.g. a methyl group such as CH₃ in particular, R′₃ represents, e.g. a methoxy group such as —O—CH₃ in particular, and R′₄ represents, e.g. a methyl group such as CH₃ in particular.

This photochromic compound is sold in particular by the Japanese company Kobe Natural Products, of Kobe, Japan and it is also available from Prof. Mashiro Irie, Kyushu University, Japan (see also the publication by M. Irie and K. Uchida in Bull. Chem. Soc. Jpn, 71, 985 (1988)). This substance is also described in document JP-2 711 212.

It comprises a bistable photochromic compound with memory, which is initially in an A form presenting little color and which can be colored blue by being irradiated with ultraviolet (UV) at a wavelength of 334 nm so as to switch to a B form.

The photochromic compound is advantageously mixed with an optically inert transparent polymer such as polymethacrylate (PMMA), polycarbonate (PC), or polyvinyl butyral (PVB) for example. The concentration of the photochromic compound preferably lies in the range 10% to 30% by weight relative to the transparent polymer.

The mixture is deposited in solution on the data carrying face of the matrix 6, after data has been recorded on this face but before metallization. Deposition is advantageously performed by centrifuging (spin coating), i.e. by causing the matrix 6 to spin so as to make the thin layer 5, where appropriate after sticking a removable mask on any portion of the matrix 6 which is not to receive the layer 5.

To make up the solution containing the photochromic compound, it is possible to put the optically inert polymer into solution in a solvent or a mixture of solvent such as: methyl ethyl ketone (MEK), cyclo-hexanone, cyclohexanol, trichlorethylene, chlorobenzene, toluene, etc., for example, at a concentration of about 5% to 20% by weight depending on the thickness desired for the layer 5. The photochromic compound is then added to the solution at the desired concentration.

After the layer 5 of photosensitive material has been deposited, the layer of metallization 7 is deposited and then the protective layer 8.

The photochromic compound is then in its A state so that the layer 5 is transparent.

The layer 5 is then colored blue by subjecting it to UV radiation at a wavelength of 334 nm, thereby causing the photochromic compound to switch to its B state (blue color).

The label 10 is then placed on the photosensitive portion 5 of the disk or this portion is kept in darkness by any other means throughout the time disk 1 is in storage so as to ensure that said coloring remains stable.

As shown in FIG. 3, for the particular case of a DVD, the photosensitive layer 5 can be constituted by a layer of adhesive interposed between two superposed substrates 11 and 12 carrying the data stored in the DVD.

Under such circumstances, the photosensitive layer 5 comprises both an active compound selected from the examples cited above, and a transparent polymer suitable for sticking together the two substrates 11 and 12.

The transparent polymer is preferably a photopolymer adapted to polymerize in the presence of UV radiation.

More particularly, it can be a polyacrylate including a specially selected photoinitiator (in particular polyacrylic resin containing 0.1% to 15% of the “Irgacure 1700” photoinitiator sold by Novartis and compatible with the photochromic compound).

It should also be observed that the layer 5 of photosensitive material could extend over only a fraction of the facing surfaces of the substrates 11 and 12, in which case the substrates would contain between them only the photopolymer such as a polyacrylate over the remainder of the surface of the DVD.

The concentration of the photochromic compound in the layer 5 can lie in the range 10% to 30% by weight, for example, or indeed in the range 1% to 30% by weight, relative to the transparent polymer, as in the preceding example, and the method of depositing the layer 5 is otherwise identical or similar to that described above, the thickness of the layer 5 likewise lying in the range 0.2 μm to 10 μm, or indeed in the range 0.2 μm to 60 μm.

Once the layer 5 has been deposited on one of the substrates 11 and 12 (e.g. the substrate 12), the other substrate 11 of the DVD is superposed on said layer 5 and the DVD is exposed to UV radiation at a wavelength of 334 nm, assuming that the photochromic compound is the above-mentioned compound of formula II, thus causing it to take up a B state (blue color) while simultaneously polymerizing the polyacrylate of the layer 5 and thus bonding together the two substrates 11 and 12.

As in the above-described example, the label 10 is then put onto the photosensitive portion 5 of the DVD, or said portion is kept in the dark by any other means throughout the time disk 1 is in storage, so that the color of the photosensitive portion 5 remains stable.

The resulting optical disk 1 (FIG. 2 or FIG. 3) can be used as follows, for example.

On first use of the disk 1, the label 10 is removed to allow the photosensitive layer to be exposed to the read laser beam 9 when the disk 1 is subsequently inserted into an appropriate reader, e.g. forming part of a microcomputer or other electronic appliance.

When the disk 1 begins to be read, the photochromic compound is in the B form and prevents the read laser beam 9 from reading the data carried by the disk in register with the photosensitive portion 5.

After being exposed to the read laser beam 9 for a predetermined length of time, which beam has a wavelength of 635 nm, for example, the photochromic compound in the photosensitive portion 5 of the disk fades in those zones 5a that are scanned by the beam 9, thus enabling the data on the disk that lies in register with the photosensitive portion 5 to be read by the laser beam 9.

By way of example, when using a CD-ROM or DVD reader fitted with a laser diode operating at 1 milliwatt (mW) at 635 nm, and a photosensitive layer 5 having a thickness of 4 μm and containing 20% by weight of the above-mentioned photochromic compound in PMMA or in a polyacrylate photopolymer, the photosensitive layer 5 is subjected to fading that corresponds to a 15% variation in its light absorption on being exposed during 100 nanoseconds (ns) to the laser beam when focused to have a 0.5 μm spot (exposed surface). This sensitivity corresponds to energy density of a few nanowatts (nW) per square centimeter (cm²) for causing the photochromic compound to fade.

The computer or other electronic appliance controlling the optical disk reader can thus check that the photosensitive material is present on the optical disk, e.g. by verifying that at least some of the disk data is initially unreadable and that it subsequently becomes readable after being exposed for a predetermined length of time to the read laser beam 9, thereby guaranteeing firstly that the optical disk is an original, and secondly that it has never been used.

During verification of the optical disk, it is possible, in particular, to use the identification and security processes described in the above-mentioned document EP-A-0 903 732.

Thus, for example, it is possible to prevent software carried by the optical disk being installed on multiple occasions. Naturally, this particular application is given by way of non-limiting example.

It should also be observed that the photosensitive material can be deposited on the optical disk so as to occupy a complex pattern, or that it can be colored by being exposed to UV through a mask having a complex pattern, thus making the process of authenticating the original optical disk more complex.

The photosensitive material can also be deposited locally on the optical disk using a conventional method such as an ink jet type method or microlithography, in particular.

Furthermore, when the read light beam is an ultraviolet beam, e.g. occupying the 300 nm to 400 nm wavelength range, at least in part, it is possible to cause the photochromic compound to operate in a process that is the inverse of the above-described process. In other words, the photochromic compound is initially left colorless so that when the optical disk (e.g. a DVD) begins to be used, the photochromic compound allows the disk to be read by the read light beam. Subsequently, once the zone that includes the photochromic compound has received sufficient light energy from the read light beam, the material takes on the blue color and then prevents the data which is covered by said photochromic compound from being read.

The computer or other electronic appliance controlling the optical disk reader can then check that the photosensitive material is present on the optical disk by verifying that the photosensitive zone changes state, and where appropriate by verifying the exposure time required to obtain this change of state, thus making it possible to authenticate the optical disk.

I claim

1/ A secure, optically readable data medium comprising a data-carrying zone that is readable by a read light beam, and at least a portion that is photosensitive, being provided with a photosensitive material and exposed to the read light beam, the photosensitive material presenting at least one optical property that can be modified by the read light beam, wherein the photosensitive material contains an active compound taken from the diarylethene family.

2/ A data medium according to claim 1, in which the compound from the family of diarylethenes is a substituted or non-substituted compound having the following general formula: 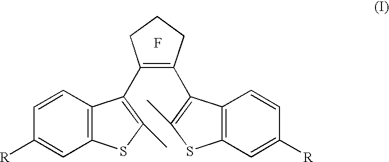
in which R represents a substituted or non-substituted styryl radical.

3/ A data medium according to claim 2, in which the compound from the family of diarylethenes is a substituted or non-substituted compound having the following general formula: 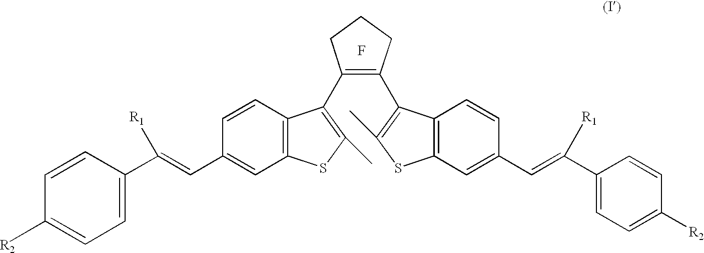
in which:
R₁ and R₂ are each selected independently of each other from: a hydrogen atom; a C1 to C6 alkyl group; and a C1 to C6 alcoxy group.

4/ A data medium according to claim 3, in which R₁ represents a hydrogen atom and R₂ represents —O—CH₃.

5/ A data medium according to claim 3, in which R₁ represents CH₃ and R₂ represents a hydrogen atom.

6/ A data medium according to claim 1, in which the compound from the family of diarylethenes is a substituted or non-substituted compound having the following general formula: 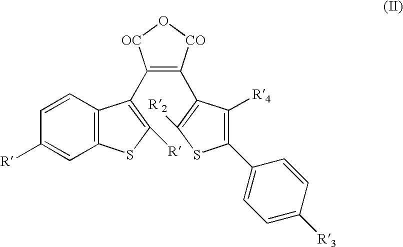
in which each of R′, R′₁, R′₂, R′₃, and R′₄ is selected independently of one another from: a hydrogen atom; an alkyl group; and an alcoxy group.

7/ A data medium according to claim 6, in which R′ represent a hydrogen atom, R′₁ represents —O—CH₃, R′₂ and R′₄ represents CH₃, and R′₃ represents —O—CH₃.

8/ A data medium according to claim 1, constituting an optical disk.

9/ A data medium according to claim 8, selected from CD-ROMs and DVDs.

10/ A data medium according to claim 1, having a data zone which includes at least part of said photosensitive portion.

11/ A data medium according to claim 1, comprising a transparent matrix having a data-carrying face on which said photosensitive material is deposited in the form of a fine layer, the layer of photosensitive material and the data-carrying face of the matrix being covered in a reflecting layer of metallization.

12/ A data medium according to claim 1, in which the photosensitive material is in the form of a layer of thickness lying in the range 0.2 μm to 60 μm.

13/ A data medium according to claim 1, in which the photosensitive material also comprises a solid transparent polymer having the active compound of said photosensitive material mixed therein.

14/ A data medium according to claim 13, in which the active compound is at a concentration of 10% to 30% by weight relative to the transparent polymer.

15/ A data medium according to claim 1, in which the photosensitive material is blue in color and is adapted to fade on receiving sufficient light energy in a wavelength range that includes the wavelength value 635 nm.

16/ A data medium according to claim 1, in which the photosensitive material is colorless and is adapted to become colored blue on receiving sufficient light energy in a wavelength range lying at least in part in the range 300 nm to 400 nm.

17/ A data medium according to claim 1, in which the photosensitive portion of the data medium is covered by a removable opaque mask (10).

18/ A data medium according to claim 1, constituting a DVD comprising two substrates (11, 12) bonded together by means of an intermediate layer (5) formed at least in part by said photosensitive material, said intermediate layer (5) comprising at least the active compound of said photosensitive material together with a solid transparent polymer which adheres to both substrates (11, 12) of the DVD.

19/ A data medium according to claim 18, in which said transparent polymer is a photopolymer.

20/ A data medium according to claim 19, in which said photopolymer is adapted to polymerize on being irradiated with ultraviolet radiation.

21/ A process for checking that an optically readable data medium is an original, said optically readable data medium comprising a data carrying zone that is readable by a read light beam and at least a portion that is photosensitive, being provided with a photosensitive material and exposed to the read light beam, the photosensitive material presenting at least one optical property that can be modified by the read light beam, the photosensitive material containing an active compound taken from the diarylethenes family,
said process comprising at least a first step in which the data medium is read by said read light beam, and a second step in which one checks that said at least one optical property of the photosensitive material was modified during said first step.
